(19) United States
(12) Patent Application Publication
(10) Pub. No.: US 2012/0324793 A1
(43) Pub. Date: Dec. 27, 2012

(54) VEHICLE COMPARTMENT CLOSURE APPARATUS

(76) Inventors: Arif Abbasi, Ann Arbor, MI (US); Andrew R. Kavc, Oxford, MI (US); Gerald J. Wenzloff, Milford, MI (US); Paul Stibich, Troy, MI (US); Nick Antenucci, Waterford, MI (US); Carl Wayne Stroope, Oxford, MI (US); David B. Reed, Lake Orion, MI (US)

(21) Appl. No.: 13/167,117

(22) Filed: Jun. 23, 2011

(51) Int. Cl. B60J 5/12; B60J 5/00

(52) U.S. Cl. 49/168

(57) ABSTRACT

A vehicle compartment closure apparatus is provided. The closure apparatus includes a frame member and a door. The frame member is configured to be operably coupled to the vehicle contiguous with the compartment. The frame member is further configured to be operably coupled to a plurality of single and dual door configurations. The door is coupled to the frame member. At a first operational mode, the door and the frame member are rotatable about a first axis between an open position and a closed position. At a second operational mode, the door is rotatable about a second axis between an open position and a closed position, and the frame member does not move with the door.

### CROSS-REFERENCE TO RELATED APPLICATIONS

The present disclosure relates to, and is entitled to the benefit of the earlier filing date and priority of, U.S. Provisional Patent Application No. 61/357,752, filed Jun. 23, 2010, the disclosure of which is hereby incorporated by reference.

### FIELD

The present disclosure relates to closure apparatus for a vehicle compartment.

### BACKGROUND

Vehicles often include an area or compartment where it is desirable to block the area at one time and in such a manner as to also provide access to the same area at another time. Closure apparatus operably affixed to the vehicle, such as a door or gate, has been used to both block a vehicle compartment and later provide access to the compartment without having to completely separate the door from the vehicle. It some instances it may be desirable to have a configuration of closure apparatus that provides for a portion of the closure apparatus to be opened independent of another portion of the closure apparatus. It may be further desirable to have a configuration of closure apparatus where at least a portion of the closure apparatus moves in a plurality of directions to block off or allow access to the vehicle compartment.

### SUMMARY

Provided herein are exemplary embodiments of a multi-function closure apparatus for a vehicle compartment.

In one aspect, the closure apparatus includes a frame member and a door. The frame member is configured to be operably coupled to the vehicle contiguous with the compartment. The frame member is further configured to be operably coupled to a plurality of single and dual door configurations. The door is coupled to the frame member. At a first operational mode, the door and the frame member are rotatable about a first axis between an open position and a closed position. At a second operational mode, the door is rotatable about a second axis between an open position and a closed position, and the frame member does not move with the door

In another aspect, the closure apparatus includes a first door, a second door, and a frame member. The first door is coupled to the vehicle contiguous with the compartment. The second door is coupled to the vehicle contiguous with the compartment. The frame member is configured to be operably coupled to the vehicle and the first and second doors. At a first operational mode, the first door and the second door are operably coupled together, and the coupled first and second doors are rotatable about a first axis between an open position and a closed position, and the frame member moves with the coupled first and second doors. At a second operational mode, the first door is rotatable about a second axis and the second door is rotatable about a third axis, and the first and second doors are capable of moving away and toward each other about their respective axis between an open position and a closed position, and the frame member does not move with the first and second doors.

Further areas of applicability of the present disclosure will become apparent from the detailed description, drawings and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a partial perspective view of a vehicle with a closure apparatus in accordance with an exemplary embodiment of the present disclosure;

FIG. 1A is a partial perspective view of a vehicle with a closure apparatus in accordance with another exemplary embodiment of the present disclosure;

FIG. 2 is a partial perspective view of an embodiment of a frame member of the closure apparatus of FIG. 1;

FIG. 3 is a partial perspective view of the closure apparatus of FIG. 1 showing the closure apparatus in an open position in a first operational mode;

FIG. 3A is a partial perspective view of the closure apparatus of FIG. 1A showing the closure apparatus in an open position in a first operational mode;

FIG. 3B is a partial perspective view of the closure apparatus of FIG. 1A showing the closure apparatus in an open position in a second operational mode;

FIG. 4 is a partial perspective view of the closure apparatus of FIG. 1 showing the closure apparatus in an open position in a second operational mode;

FIG. 5 is a perspective view an exemplary embodiment of a frame member of the closure apparatus of FIG. 1;

FIG. 5A is an enlarged perspective view of the hinge shown with the frame member of FIG. 5;

FIG. 5B is an enlarged perspective view of an alternative exemplary embodiment of the hinge shown with the frame member of FIG. 5;

FIG. 6 is a partial perspective view of the closure apparatus of FIG. 1 showing the closure apparatus in another open position in a second operational mode;

FIG. 7 is a perspective view of a torsion bar assembly in accordance with an exemplary embodiment of the closure assembly;

FIG. 7A is an enlarged partial perspective view showing a left side of the torsion bar assembly of FIG. 7;

FIG. 7B is an enlarged partial perspective view showing a right side of the torsion bar assembly of FIG. 7;

FIG. 8 is an enlarged partial perspective view showing an exemplary embodiment of an alignment device for use with the doors of the closure apparatus;

FIG. 9 is an enlarged partial perspective view showing an exemplary embodiment of a latch and a support member for use with the doors of the closure apparatus; and

FIG. 10 is an enlarged partial perspective view showing another exemplary embodiment of a support member for use with the doors of the closure apparatus.

### DETAILED DESCRIPTION

Vehicle compartment closure apparatus is described in this disclosure. Various embodiments of the closure apparatus disclosed herein include a frame member contiguous with a compartment of the vehicle and one or more doors operably coupled to the frame member. The frame member is further configured to be operably coupled to a plurality of single and dual door configurations. In one exemplary embodiment, a door is operably coupled to the frame member and the door and the frame member rotate about a first axis between an open position and a closed position, in a first operational mode. In a second operational mode, the door rotates about a second axis between an open position and a closed position, and the frame member does not rotate with the door. In an exemplary embodiment, the first axis is substantially perpendicular to the second axis.

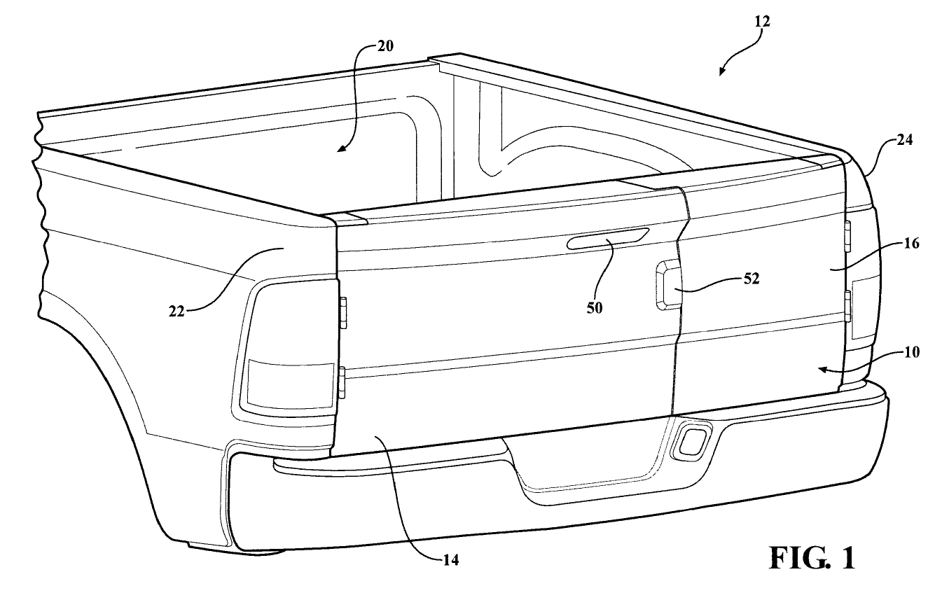

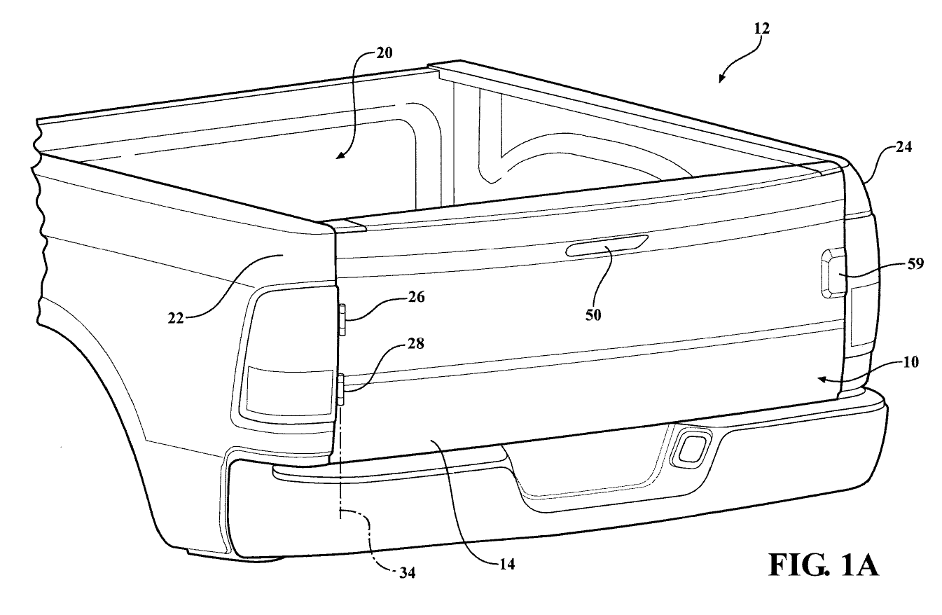

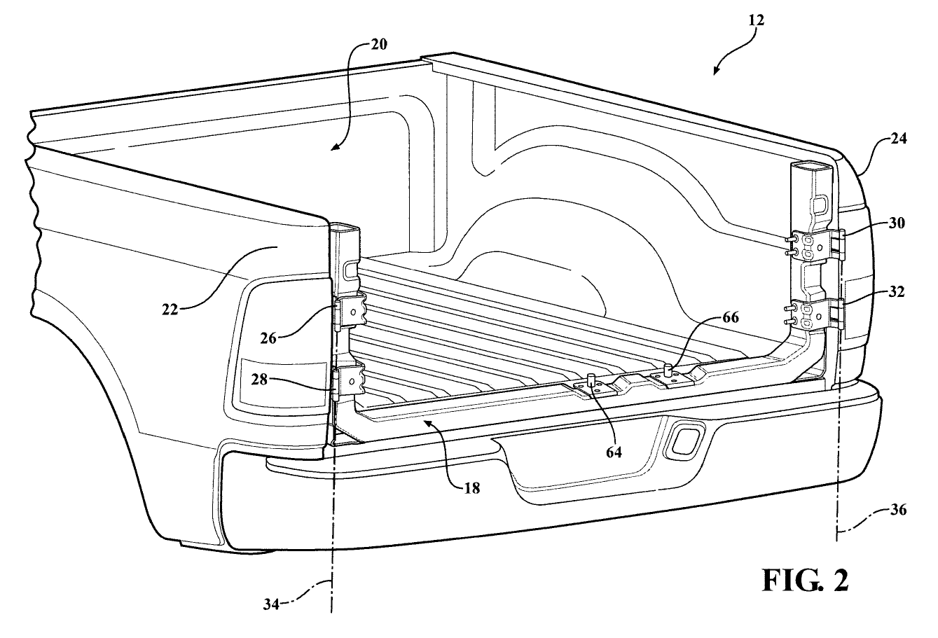

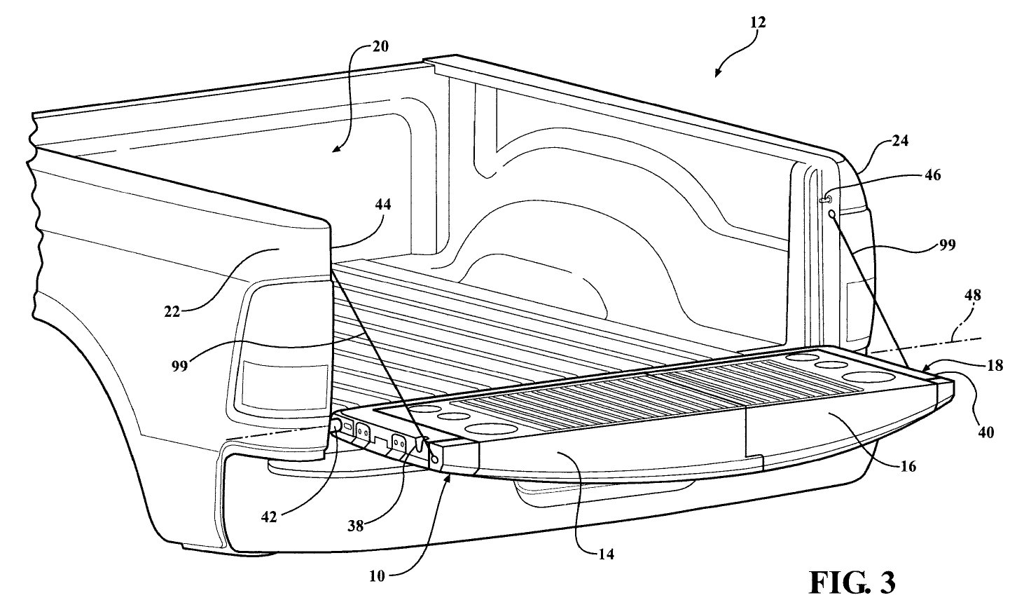

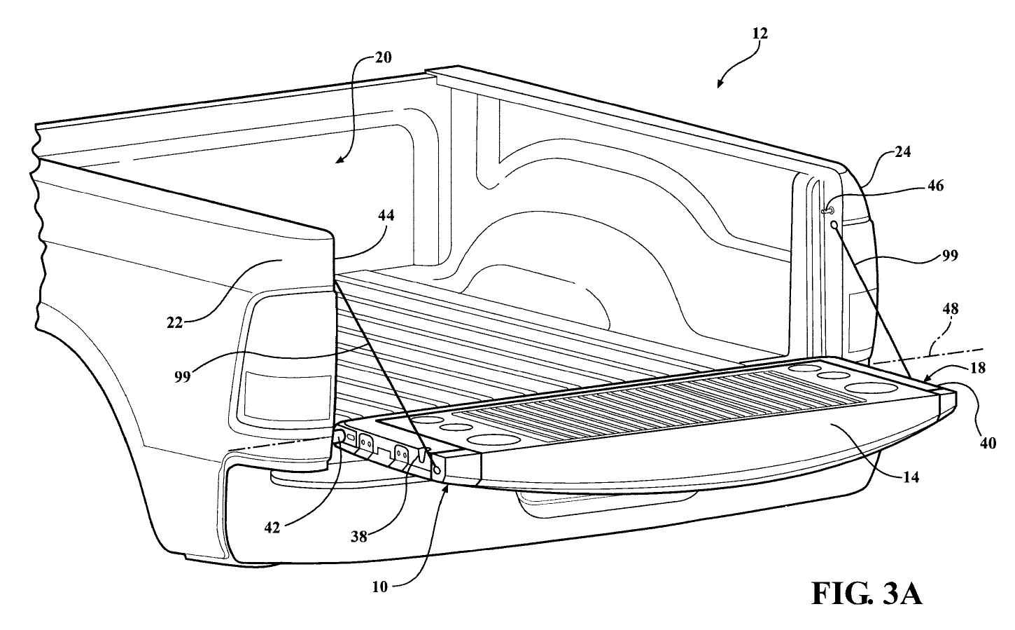

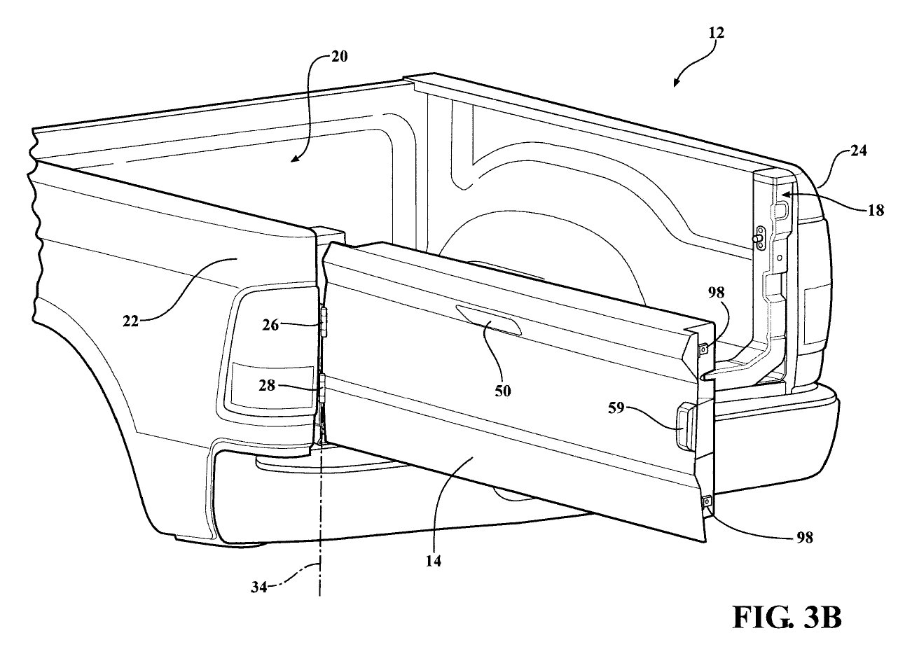

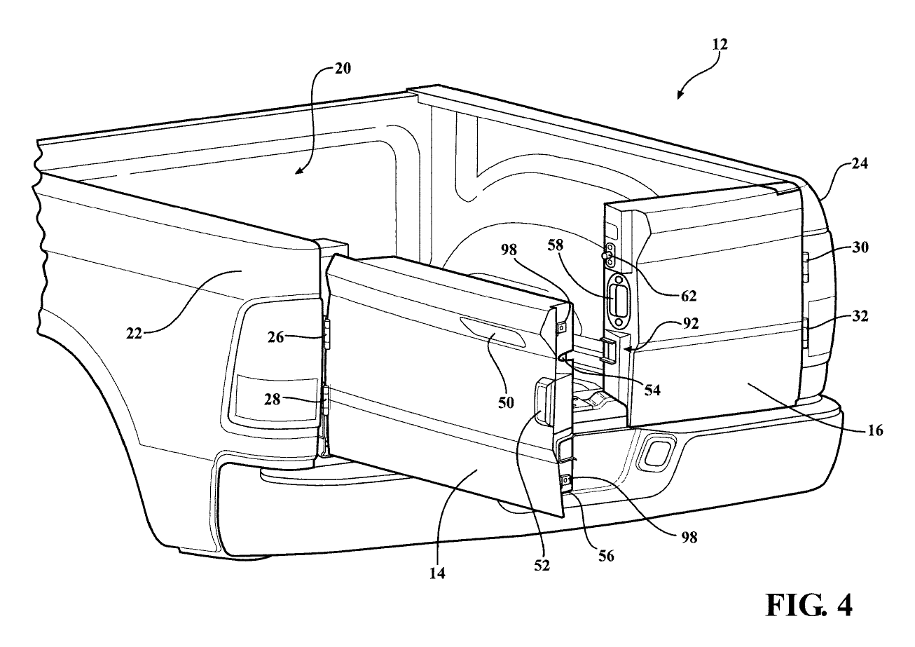

In another exemplary embodiment, the closure apparatus includes two doors coupled to the vehicle contiguous with a compartment of the vehicle, shown in FIGS. 1 and 4. The apparatus further includes an embodiment of a frame member, shown in FIG. 2. The apparatus is configured so the frame member is operably coupled to vehicle structure. When the doors are moved in a first operational mode, the frame member moves with the doors, for example as shown in FIG. 3. When one or more of the doors are moved in a second operational mode, the frame member remains secured to the vehicle structure, shown in FIG. 4.

In certain embodiments, the closure apparatus is configured to be interchangeable with one or more doors of an existing vehicle. For example, an existing tailgate door (single or dual door configuration) can be removed and replaced with a closure apparatus (door) configuration different than what was previously used with the vehicle.

In some embodiments, the frame member mounts to the vehicle substantially similar to a current tailgate door. Configurations of the closure apparatus can utilize various door mechanisms such as latches, alignment devices, pivots, stops, strikers, bumpers, locks, etc. The frame member can be machined, a formed construction, a weldment, a fabrication, can include other mechanisms or portions thereof integrally formed within, and combinations thereof. The frame member can be configured to receive operably a variety of door or gate configurations such as single door, dual, swinging door(s), drop-down, etc. thereby providing closure apparatus (e.g. tailgate) removability, interchangeability, and versatility. The embodiments of closure apparatus contemplated herein can incorporate conventional door mechanisms such as hinges and latches or configurations of mechanisms that provides unique capabilities such as a particular component locating aspect, a unique operational sequence, a unique locking arrangement, recessed and depressible portions etc. In some embodiments, the frame member includes, and/or is configured to function as a torsion rod. The configuration provides assistance/support in holding and or moving materials.

Referring to FIGS. 1-3, a vehicle compartment closure apparatus 10 coupled to a vehicle 12 is illustrated. Closure apparatus 10 includes a first door 14, a second door 16, and frame member 18. First and second doors 14, 16 in an opened position allow access to a vehicle compartment 20 and the doors aid in containing items in the compartment when the doors are in a closed position, for example as shown in FIG. 1. Frame member 18 is operably coupled to vehicle structure 22, 24 and to the first and second doors 14, 16. In this embodiment, the doors 14, 16 are of a substantially steel construction and the frame member 18 is a single, U-shaped steel piece that when coupled to the vehicle structure 22, 24 the frame member extends along three regions of the vehicle contiguous with the vehicle compartment 20. In an alternative embodiment, the doors and/or frame member may include another metal or non-metal material such as a high-strength plastic, a composite, a fabrication and combinations thereof.

In the embodiment in FIG. 1, a 65/35 split door configuration, a length of the first door 14 is approximately 65% of the combined doors length in their closed portion and a length of the second door 16 is approximately 35% of the combined doors length. In another exemplary embodiment, the doors can be split as another percentage, for example a 50/50 split door configuration, where a length of each of the first door and second door 14, 16 is approximately 50% of the combined doors length. FIG. 1 illustrates the closure apparatus is a tailgate, used with a truck bed area, compartment 20, but exemplary embodiments of closure apparatus disclosed herein are applicable to other vehicle types having compartments where access and closure thereto is desirable, for example, SUVs, station wagons, converted cars, etc.

Referring to FIGS. 2 and 3, an exemplary embodiment of closure apparatus 10 is illustrated in more detail. Coupled to frame member 18 is a top left hinge 26, a bottom left hinge 28, a top right hinge 30, and a bottom right hinge 32. The hinges 26, 28 are aligned along the frame member 18 and an edge of the first door 14 adjacent vehicle structure 22 so the first door moves, rotates, about an axis 34 aligned with the hinges 26, 28 in the second operational mode. The hinges 30, 32 are aligned along the frame member 18 and an edge of the second door 16 adjacent vehicle structure 24 so the second door moves, rotates, about an axis 36 aligned with the hinges 30, 32 in the second operational mode.

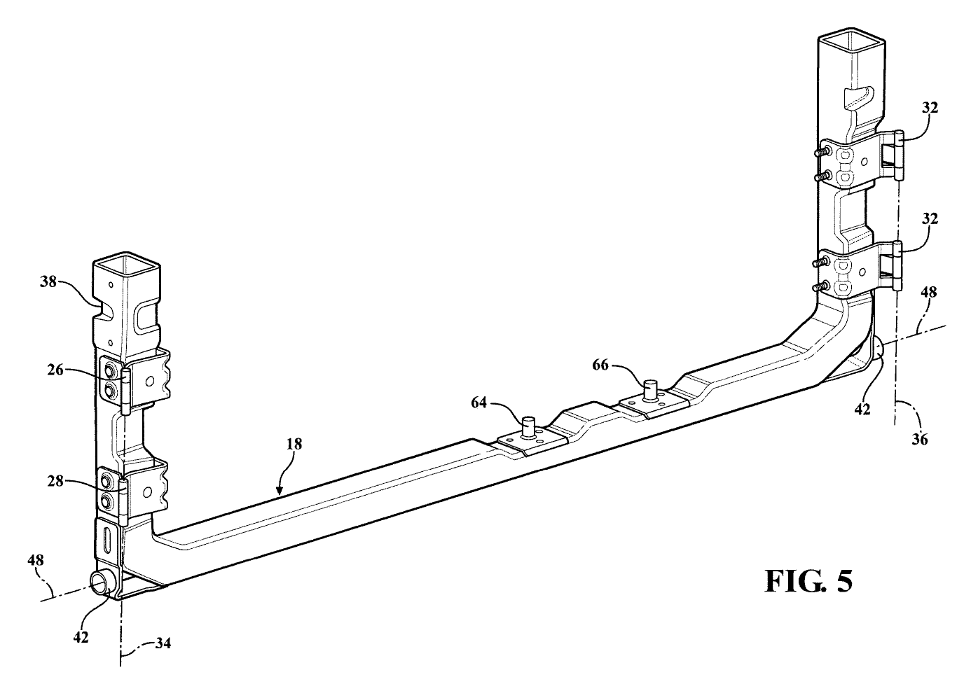

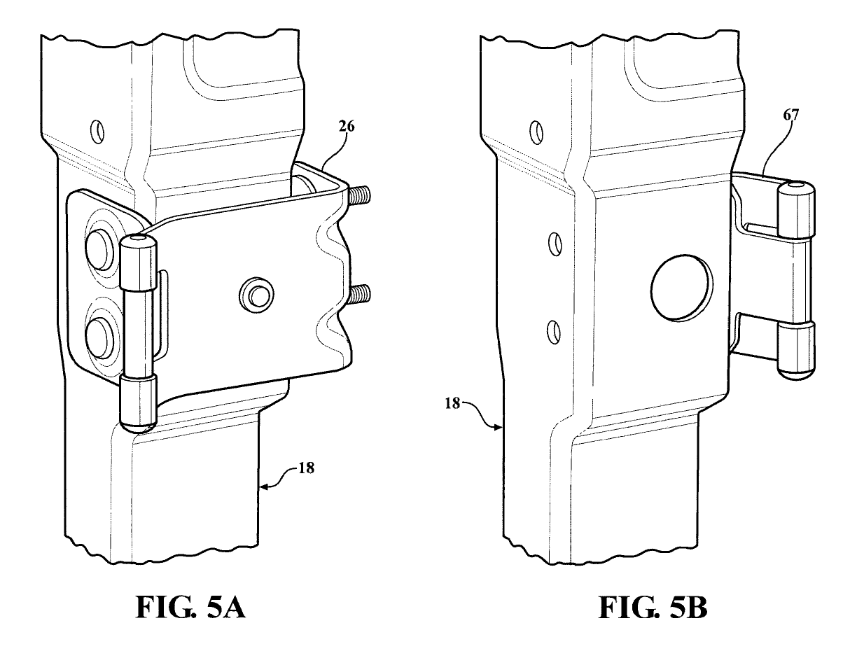

Referring to FIG. 3, further coupled to the frame member 18 is a left latch 38, a right latch 40, and a pivot portion 42. The left latch 38 is configured to engage a striker 44 joined to vehicle structure 22 when the first and second doors 14, 16 are in the closed position in the first operational mode. The right latch 40 is configured to engage a striker 46 joined to vehicle structure 24 when the first and second doors 14, 16 are in the closed position in the first operational mode. Pivot portion 42 is aligned with an axis 48 that extends along a bottom portion of the frame member. Pivot portion 42 is configured so in the first operational mode, the coupled doors 14, 16 can be moved, rotated, about axis 48 (shown in FIG. 5) to an open position as shown in FIG. 3. Axis 48 extends along a lower portion of the U-shaped frame member beneath hinges 26, 28, 30, 32. Pivot portion 42 is further configured to engage a portion of vehicle structures 22 and 24 in a manner so the coupled doors 14, 16 can move about axis 48 in the first operational mode. Further, the pivot portion can be configured to include a detent to limit the amount of rotation of the doors about an axis, for example, to rotate to an extent that an inner surface of the door(s) is substantially on a same plane with a surface of the compartment.

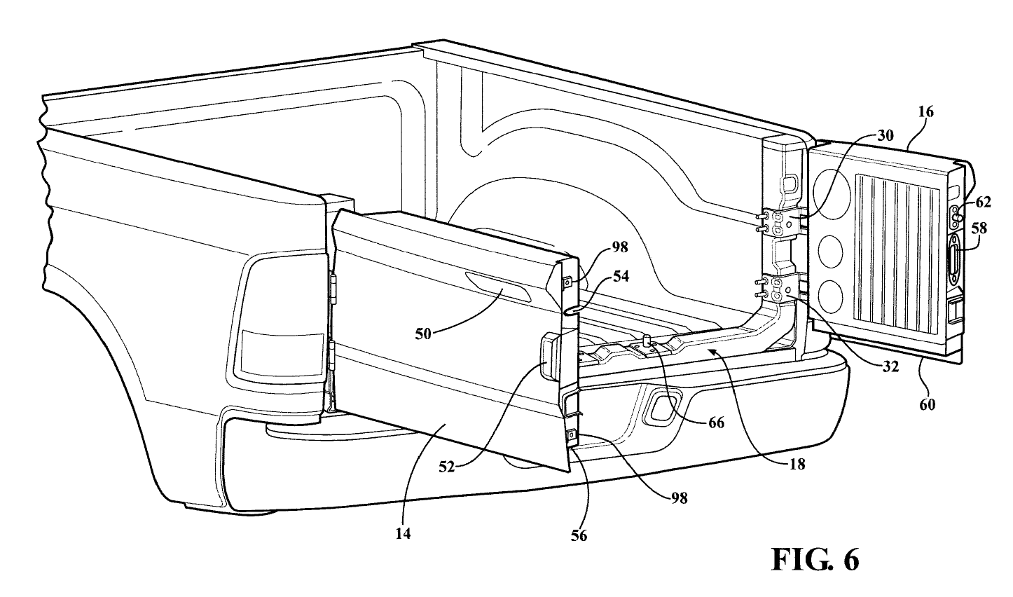

In an exemplary embodiment and referring to FIGS. 4 and 6, the first door 14 includes a first handle 50, a second handle 52, a top latch 54, and a bottom latch 56 (not shown, but can be of a configuration substantially similar to top latch 54). The second door 16 includes a third handle 58, a bottom latch 60, and a striker 62. The top latch 54 of the first door 14 is configured to engage the striker 62 of the second door 16 to couple the first door to the second door. The bottom latch 56 of the first door is configured to engage a striker 64 joined to the frame member 18 to couple the first door to the frame member. The bottom latch 60 of the second door is configured to engage a striker 66 joined to the frame member 18 to couple the second door to the frame member.

The handle 50 is operably coupled to the left latch 38 and the right latch 40, both latches coupled to the frame member 18 as shown in FIGS. 3 and 5. The left latch 38 is positioned and configured to engage a striker 44 joined to vehicle structure 22 when the coupled doors 14, 16 are at the closed position, as shown in FIG. 1. Right latch 40 is positioned and configured to engage a striker 46 joined to vehicle structure 24 when the coupled doors 14, 16 are at the closed position, as shown in FIG. 1.

The handles can be operably coupled to latches and configured for actuating the latches between engagement and non-engagement with respective strikers via methods such as mechanical, cabling, springs, electrical switches that actuate the latches, sensors, electro-mechanical methods, remote methods using key-fobs, and combinations thereof.

The first door 14 is joined to hinges 26, 28 to operably couple the first door to the frame member 18 where the first door moves about the axis 34. The second door 14 is joined to hinges 30, 32 to operably couple the second door to the frame member where the first door moves about the axis 36.

Operation of the first and second doors 14, 16 according to a first operational mode will now be described in accordance with an exemplary embodiment. In the first operational mode the first door 14 is coupled to the second door 16 and both doors are coupled to the frame member 18 and move between an open position (FIG. 3) and a closed position (FIG. 1). Latches and strikers are utilized so the coupled doors 14, 16 are securely held to the vehicle in the closed position when the latches are engaged with the strikers. The latches are also configured to release from engagement with their respective striker so the coupled doors can be moved from the closed position to an open position. In this first operational mode the coupled doors move together as a single door between closed and open positions.

In the first operational mode, to move the coupled doors 14, 16 from the closed position, FIG. 1, to an open position, FIG. 3, the first handle 50 is utilized to actuate the left latch 38 and the right latch 40 to disengage the latches 38, 40 from their respective strikers 44, 46 at corresponding vehicle structure 22, 24. In the first operational mode, the first and second doors remained coupled together as top latch 54 at the first door remains engaged with striker 62 at the second door, the bottom latch 56 at the first door remains engaged with striker 64 at the frame member 18, and the bottom latch 60 at the second door remains engaged with the striker 66 at the frame member, thereby coupling the first and second doors together and to the frame member. The coupled doors 14, 16 rotate together with the frame member about the axis 48 in the first operational mode between the open and closed positions. In this first operational mode the coupled doors 14, 16 and the frame member 18 move together between closed and open positions. In an exemplary embodiment, the axes 34, 36 are substantially perpendicular to axis 48.

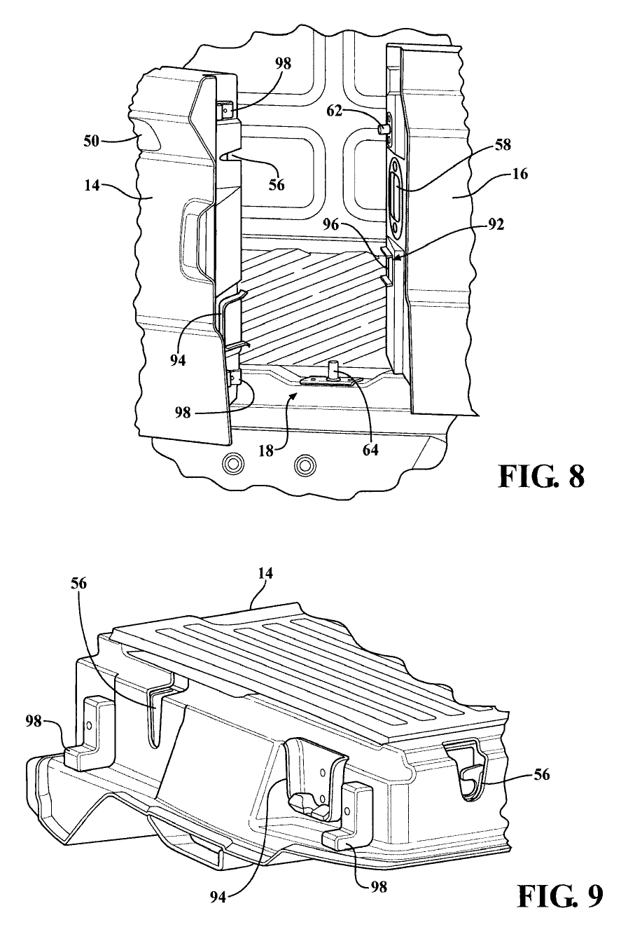

The latches described herein can be of a type commonly used such as a mechanical, spring biased type with a portion of the latch snapping about the striker to engage the striker when the first door is in the closed position. An example configuration of the latch, here bottom latch 56 of the first door 14, is shown in FIG. 9. The strikers described herein can be stationary protrusions, e.g. posts, rings, bars, etc. The strikers can be an integral portion of the member where they are positioned or the strikers can be separate components joined to the members. An example of a striker (62) configuration is shown in FIG. 8. A cable can be utilized with a handle and a latch to actuate the latch. For example, when the handle is moved the latch is actuated via the cable to disengage a spring biased latch engaged with a respective striker, to open the door when the door is in the closed position. In an alternative embodiment, the handle and the latches/strikers can be configured to actuate the latches to disengage and engage the strikers via other common mechanical components, electrical components, electro-mechanical components, magnetic components, and combinations thereof, to thereby permit movement of the door(s) between the open and closed positions. In another embodiment, the handle can be a locking handle via key or combination key pad, to permit actuation of the latches to move the door(s) from the closed position to an open position.

Referring now to FIGS. 1, 4 and 6, operation of first and second doors 14, 16 according to a second operational mode will now be described in accordance with an exemplary embodiment. In the second operational mode each door is configured with the vehicle to move between an open position and a closed position. Each door utilizes at least one latch and a striker configured so the door is securely held in the closed position when the latch is engaged with the striker and the latch is also configured to release from engagement with the striker so the door can be moved from the closed position to an open position.

In an exemplary embodiment, to move the first door 14 from the closed position as shown in FIG. 1, to an open position as shown in FIG. 4, the second handle 52 is moved which actuates the top latch 54 at the first door to disengage the top latch from the striker 62 at the second door 16, and actuates the bottom latch 56 at the first door to disengage the bottom latch from the striker 64 at the frame member 18. After the latches disengage from their respective strikers, the first door 14 can then be moved, rotated, about an axis 34 to an open position as shown in FIG. 4. When the first door is not coupled to the second door, the first door is supported by hinges 26, 28. In the embodiment shown in FIG. 4, when the first and second doors are coupled together in the closed position, the door 14 is supported by hinges 26, 28; latch 54 engaged with striker 62 and latch 46 engaged with striker 64. As will be discussed herein bumpers 98, centering device 94 and frame member 18 can also aid in supporting the door 14.

In an exemplary embodiment, to move the second door 16 from the closed position as shown in FIG. 1, to an open position as shown in FIG. 6, the third handle 58 is moved which actuates the bottom latch 60 at the second door to disengage the bottom latch from the striker 66 at the frame member 18. After the latch 60 disengages from striker 66, the second door 16 can then be moved, rotated, about an axis 36 to an open position as shown in FIG. 6. When the second door is not coupled to the first door, the second door is supported by hinges 30, 32. When the doors are coupled together, door 16 can be supported by hinges 30, 32, latches, strikers, bumpers 62, 66, centering device, and the frame member as discussed above with respect to door 14.

In a single door 14 configuration with the frame member 18 as shown in FIGS. 1A, 3A and 3B, the frame member would include two hinges 26, 28 on the left side of the door at the frame member. The door would include one or more latches configured for engagement with striker(s) positioned at the frame member. The handle 50 would be configured to actuate the one or more latches, to rotate the single door 14 and frame member 18 about axis 48 to move the door between opened and closed positions in the first operational mode, shown in FIG. 3A. The door can include another handle 59 positioned on a side of the door away from the hinges 26, 28 for actuation of door latches for rotating the single door about axis 34 (along hinges 26, 28) to move the door between opened and closed positions in the second operational mode, as shown in FIG. 3B. The frame member would otherwise couple to the vehicle structure 22, 24 as described hereinabove.

Referring to FIGS. 2 and 5, an exemplary embodiment of frame member 18 is shown. The frame member is a U-shaped, formed part with hinges 26 and 28 joined to one upper leg and hinges 30 and 32 joined to the other upper leg of the frame member. The frame member further includes strikers 64, 66 positioned at a lower portion of the frame member for use with the bottom latch 56 of the first door 14, and the bottom latch 60 of the second door 16, respectively. The strikers 64, 66 are shown as posts, but can have another configuration, e.g. rings, to compliment a particular latch configuration. Additionally, the strikers can be separate components or an integral portion of the frame member.

In this embodiment of the frame member, the hinges are separate components coupled to the spaced apart upper legs, as shown in FIGS. 5 and 5A. In an alternative embodiment of the frame member, a hinge 67 can have a more concealed configuration with the leg of the framed member, as shown in FIG. 5B. The latch 38 is positioned above hinges 26, 28 for use with the first door 14 as discussed hereinabove. The latch 40 is positioned above hinges 30, 32 for use with the second door 16 as discussed hereinabove. In some alternative embodiments of the frame member, similar to the hinges, the latches may be separate components joined to the frame member or at least some latch components may be integral with the frame member.

Pivot portion 42 is positioned at the lower portion of the frame member along the axis 48. A pivot portion is positioned on each lower outward side of the frame member proximately under each of the upper legs. Each pivot portion is configured to engage a portion of the vehicle structure 22, 24, respectively, and configured with the frame member 18 for rotation of the doors and frame member about axis 48 when the frame member is coupled to the first and second doors to move the doors between the open and closed positions in the first operational mode.

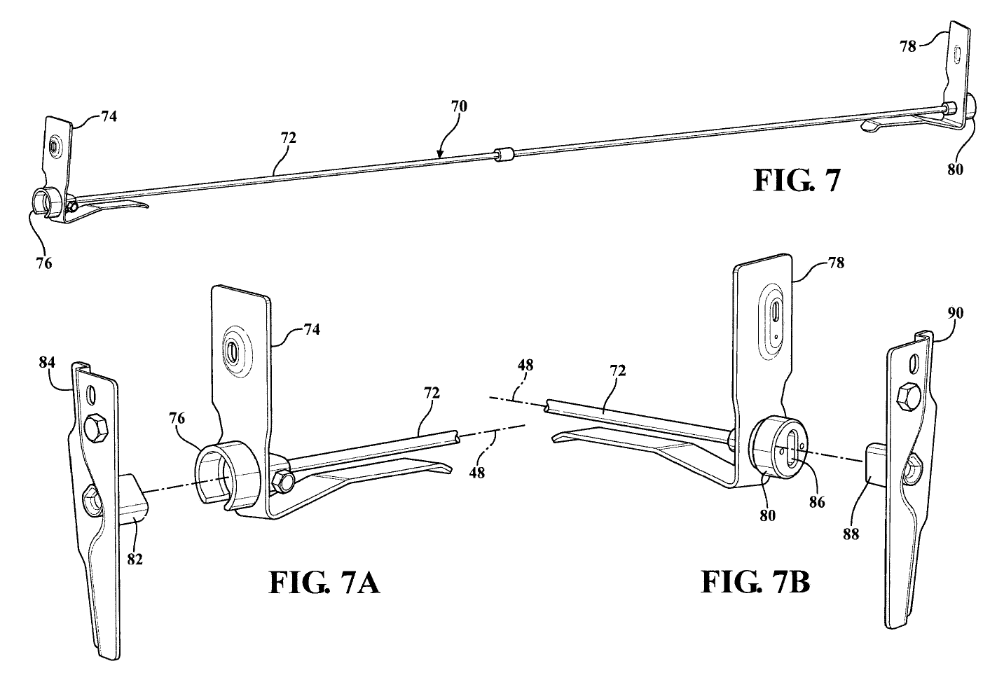

Referring to FIGS. 7, 7A and 7B, a torsion bar assembly 70 is shown for use with the frame member 18 in accordance with an exemplary embodiment of the closure apparatus. The torsion bar assembly supports the frame member 18 and functions to assist in lifting the coupled doors 14, 16 in the first operational mode, relative to the vehicle structure 22, 24. Torsion bar 70 includes an elongated rod 72, a left rod bracket 74, a left pivot cup 76, a right rod bracket 78 and a right pivot cup 80. The rod 72 is positioned within the frame member and extends along the axis 48 substantially from one upper leg to the other upper leg of the frame member. The left end of the rod 72 is joined with the left rod bracket 74 that may be joined to the upper leg of the frame member. The left pivot cup 76 is joined to the left rod bracket 74. Here, the left pivot cup 76 is formed as a C-shaped collar. The left pivot cup 76 is configured to engage a rectangular shaped left male pivot 82. The left male pivot is joined to a left male bracket 84 that is configured to be coupled to a portion of the vehicle structure 22, or in some embodiments, the left male bracket 84 and left male pivot 82 may be an integral portion of the vehicle structure 22.

The right end of the rod 72 is joined with the right rod bracket 78 that may be joined to the upper leg of the frame member. The right pivot cup 80 is joined to the right rod bracket 78. Here, the right pivot cup 80 is formed as a collar having an oval shaped recess 86. The recess 86 of the right pivot cup 80 is configured to engage a rectangular shaped right male pivot 88. The right male pivot is joined to a right male bracket 90 that is configured to be coupled to a portion of the vehicle structure 24, or in some embodiments, the right male bracket 90 and right male pivot 88 may be an integral portion of the vehicle structure 24.

The configuration of the left pivot cup 76 with the left male pivot 82 and the right pivot cup 80 with the right male pivot 88 is so the frame member can be inserted and removed from the vehicle structure 22, 24. For example, the right pivot cup can first be engaged with the right male pivot, then, the other end of the frame member or the left pivot cup can be engaged with the left male pivot. After the left pivot cup is engaged with the left male pivot, the orientation of the left pivot cup and the left male pivot can be adjusted, via adjusting the torsion rid, so the left male pivot is held within the C-shaped, curved ring, portion of the left pivot cup.

This configuration, with the left and right latches 38, 40 at the frame member 18 engaged with their respective strikers 44, 46 at the vehicle structure 22, 24, respectively, securely holds to the vehicle the torsion bar assembly 70, frame member, and the first, second doors 14, 16 during the first and second operational modes of the closure apparatus. If desired, the frame member or the entire closure apparatus can be removed by disengaging the above latches 38, 40, disengaging the left pivot cup from the left male pivot, disengaging any other connecting supports like cabling, straps, etc., and disengaging the right pivot cup from the right male pivot, to separate the frame member from the vehicle structure 22, 24.

Of course, in some embodiments, the frame member can remain attached to the vehicle structure and be configured, including hinges joined with the frame member, so just one or more doors can be removed and replaced with a different door configuration (single or dual) providing compartment closure apparatus interchangeability and versatility for the vehicle. To be clear, the inventors herein contemplated that a frame member can have a configuration that can be utilized with an existing vehicle compartment closure apparatus, e.g. an existing truck bed tailgate (single or dual doors and swing or drop down type tailgate doors), where the frame member couples to the existing vehicle (e.g. truck) structure, e.g. to the side walls, bed, latches, pivots, hinges etc., to then attach a different door configuration to the frame member as disclosed herein.

Referring to FIG. 8, an exemplary embodiment of closure apparatus having an alignment device 92 is illustrated. The alignment device is configured and positioned to align the doors together in a desirable manner, for example, so the doors do not bind each other, the hinges or the latches, to aid in intended operation of the latches, smooth door opening and closing operations, provide door support, and minimize or prevent undesirable noise or vibration of the closure apparatus when the vehicle is in operation. In this embodiment, the alignment device includes a female portion 94 positioned at the first door 14 and a male portion 96 positioned at the second door 16. For example, the male portion can be a protrusion, e.g. post, configured to be engaged with a complementary female portion, e.g. an aperture for the post. In another configuration, the alignment device could include complimentary female and male set/portions at one or more locations along the doors interface and/or doors to frame member interface.

Referring to FIG. 9, an exemplary embodiment of closure apparatus having a bumper 98 is illustrated. The bumper(s) can be configured and positioned to also aid in guiding and alignment of the doors in opening and closing operations. In this embodiment, two bumpers 98 are positioned along a side of the first door 14 that abuts a complementary side of the second door 14 when the two doors are in a closed position. In this embodiment the bumpers are positioned and configured, including a resilient material, to ensure that the first and second doors close securely and minimize or prevent undesirable noise or vibration of the closure apparatus when the vehicle is in operation. Depending on their configuration and positioning relative to the doors and frame member, the bumpers can also provide support for the doors. As with the alignment device above, in an alternative embodiment, the bumpers could have another configuration and be positioned at one or more locations along the doors interface and/or doors to frame member interface.

In another exemplary embodiment, the closure apparatus can include a movable support member that supports a door in an open position. Here, the support member(s) can be configured to maintain a surface of the doors substantially in plane with a loading surface of the compartment (e.g. truck bed floor) when the doors are in an opened position in the first operational mode. For example and referring to FIG. 3, the coupled first and second doors 14, 16 are supported by two cables 99, where one end of each cable is coupled to an upper leg of the frame member and the other end of the cable is coupled to a portion of the vehicle structure 22, 24, respectively. When the coupled first and second doors are in the closed position (as shown in FIG. 1) the support member can be configured (e.g. flexible, articulates, moves into a space of the frame member or vehicle structure) so the frame member and doors can be moved into the closed position and latched securely therein without support member impingement or otherwise interference with the frame member/door closing operation.

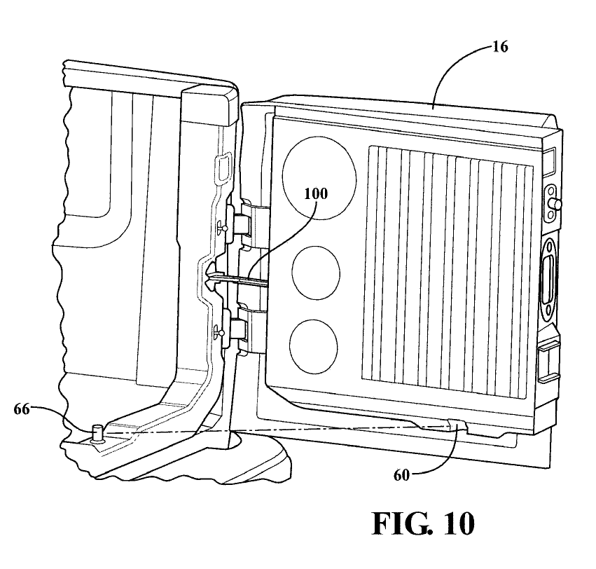

Referring to FIG. 10, a support member 100 is shown coupled to a side of the second door 16 and to the upper leg of the frame member 18 between the upper and lower hinges 30, 32. In this embodiment, the support member 100 can be positioned and configured to maintain the second door in an open position so the door does not move back toward the closed position or perhaps rotate too far away from the vehicle say past a side portion of the vehicle. It is understood the first door 14 could have a substantially similar support member or each door could have a different support member configuration to suit a design/functional objective, for example if it was desirable that one door not open past the vehicle side while the other door could open beyond the vehicle side. Here, the support member 100 can include a resilient portion, e.g. a strap, a linkage, and/or include one or more detents for door rotation stopping positions. Like the support member 98 discussed above, support member 100 can be positioned and configured so the frame member and doors can be moved into the closed position and latched securely therein without support member impingement or otherwise interference with the frame member/door closing operation in the second operational mode.

What is claimed is:

1. A vehicle compartment closure apparatus comprising:
a first door coupled to the vehicle contiguous with the compartment;
a second door coupled to the vehicle contiguous with the compartment; and
a frame member configured to be operably coupled to the vehicle and the first and second doors, wherein
at a first operational mode, the first door and the second door are operably coupled together, the coupled first and second doors are rotatable about a first axis between an open position and a closed position, and the frame member moves with the coupled first and second doors, and
at a second operational mode, the first door is rotatable about a second axis and the second door is rotatable about a third axis, the first and second doors are capable of moving away and toward each other about their respective axis between an open position and a closed position, and the frame member does not move with the first and second doors.

2. The closure apparatus of claim 1, wherein the first door length is 65% of the first and second door combined length.

3. The closure apparatus of claim 1, further comprising a handle, wherein the handle is operably coupled to a latch configured so either the first or second door can be moved toward the opened position when the handle is moved at the first or second operational mode.

4. The closure apparatus of claim 1, further comprising a handle, wherein the handle is operably coupled to a latch configured so the coupled first and second doors can be moved toward the opened position when the handle is moved at the first operational mode.

5. The closure apparatus of claim 1, wherein the frame member includes a latch portion and a pivot portion.

6. The closure apparatus of claim 5, wherein the frame member further comprises a torsion bar operable with the pivot portion at the first operational mode.

7. The closure apparatus of claim 5, wherein the frame member further comprises a hinge configured to be operably coupled with the first door or the second door.

8. The closure apparatus of claim 7, wherein the frame member further comprises a striker configured for engagement with a latch for securing the first door or the second door in the closed position.

9. The closure apparatus of claim 6, wherein the frame member has a U-shape.

10. The closure apparatus of claim 1, wherein the first and second doors coupled to the frame member are configured to replace single door and split door configurations for the vehicle.

11. The closure apparatus of claim 1, wherein the first and second doors each have a support member configured to support the respective door in their opened position.

12. The closure apparatus of claim 1, further comprising an alignment portion coupled to each of the first and second doors for aligning the first and second doors.

13. The closure apparatus of claim 1, further comprising a locking portion configured for releasably securing the first and the second doors in the closed position at the first or second operational mode.

14. The closure apparatus of claim 13, wherein the locking portion is further configured for aligning the first and second doors.

15. The closure apparatus of claim 13, wherein the locking portion is an electronic locking mechanism.

16. The closure apparatus of claim 1, wherein a surface of the first and second doors is substantially aligned with a surface of the compartment when the first and second doors are at their opened position at the first operational mode

17. The closure apparatus of claim 1, wherein the first and second doors are a tailgate for a truck.

18. A vehicle compartment closure apparatus comprising:
a frame member configured to be operably coupled to the vehicle contiguous with the compartment, the frame member being further configured to be operably coupled to a plurality of single and dual door configurations; and
a door coupled to the frame member; wherein
at a first operational mode, the door and the frame member are rotatable about a first axis between an open position and a closed position, and
at a second operational mode, the door is rotatable about a second axis between an open position and a closed position, and the frame member does not move with the door.
